(19) United States
(12) Patent Application Publication
(10) Pub. No.: US 2007/0211221 A1
(43) Pub. Date: Sep. 13, 2007

(54) PROJECTION DEVICE CAPABLE OF DETERMINING TIMING FOR REPLACING FILTERS AND METHOD THEREOF

(76) Inventors: Shun-Chieh Yang, Taipei County (TW); Hsin-Nan Lin, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 11/682,890

(22) Filed: Mar. 7, 2007

(30) Foreign Application Priority Data
Mar. 9, 2006 (TW) 095107988

(51) Int. Cl. G03B 21/16

(52) U.S. Cl. 353/52

(57) ABSTRACT

When a projection device is operating, a sensor detects a current temperature inside the projection device. If a temperature variation between an initial working temperature of the projection device and the current temperature is equal to or greater than a predetermined value, the projection device outputs a warning signal to remind a user to replace a filter.

### BACKGROUND OF THE INVENTION

1. Field of the Invention

The present invention relates to a method for determining a timing for replacing a filter for a projection device, and more specifically, to a method for detecting a temperature variation to remind a user to replace the filter for the projection device.

2. Description of the Prior Art

Use of a projector has rapidly grown in popularity. For example, using a projector to present a report makes information offered by the report clearly understandable to a watching conferee in a conference. With the improvement of technology, there are four major types of digital projectors available in the market: a cathode crystal tube (CRT) projector, a liquid crystal display (LCD) projector, a digital light processing (DLP) projector, and a liquid crystal on silicon (LCOS) projector.

Because the projector generates heat while operating, there are vents installed in the projector for dissipating heat from the projector. There also is a filter installed at an air inlet for preventing dust from entering into the projector. However, when the filter is choked with dust, cooling efficiency is reduced and temperature inside the projector rises. Therefore, cleaning the filter regularly is necessary for keeping airflow at the air inlet smooth.

A prior art method for determining the timing for replacing a filter for a projector utilizes a sensor to detect a temperature inside the projector. Please refer to FIG. 1. FIG. 1 is a flowchart of the method according to a prior art. The method comprises the following steps.

Step 100: a sensor detects a current temperature inside the projector.

Step 102: determine whether the current temperature inside the projector detected in Step 100 is smaller than a predetermined value. If so, go to Step 100. If not, go to Step 104.

Step 104: the projector outputs a warning signal to remind a user to replace a filter.

The aforementioned method involves determining whether the inner temperature of the projector is smaller than the predetermined value to decide a timing for replacing the filter. It should be mentioned that the predetermined value mentioned in Step 102 is the same for every projector of the same model. However, every individual projector needs to be examined after it is manufactured. After being examined, the inner temperature of the examined projector is obtained during the first operation, and the obtained temperature will be set as an initial working temperature of the examined projector. That is to say, the initial working temperature of every individual projector is different. Therefore, the aforementioned method can not determine the right timing for replacing the filter exactly.

For example, suppose that an initial working temperature of a projector A is 50° C., an initial working temperature of a projector B is 70° C., and a predetermined value is 75° C. According to the aforementioned method, as soon as the inner temperature of the projector B raises 5° C., the projector B will output a warning signal. However, for the projector B, replacing a filter is not necessary at this moment. As for the projector A, suppose replacing a filter is necessary when its inner temperature raises to 70° C., but the projector A will not output a warning signal when its inner temperature raises to 70° C. That is because 70° C. is not equal to or greater than the predetermined value(75° C.). Therefore, the aforementioned method misjudges a timing for replacing a filter easily due to the ignorance of the difference among the initial working temperature of each individual projector.

### SUMMARY OF THE INVENTION

The present invention provides a method for determining a timing for replacing a filter for a projection device comprising detecting a current temperature inside the projection device; and outputting a warning signal for replacing the filter when a temperature variation between an initial working temperature of the projection device and the current temperature is equal to or greater than a predetermined value.

The present invention further provides a projection device capable of determining a timing for replacing filters, the projection device comprising a warning device for outputting a warning signal; a filter installed on the projection device; a sensor for detecting a current temperature inside the projection device; and a micro control unit coupled to the warning device and the sensor for controlling the warning device to output the warning signal when a temperature variation between an initial working temperature of the projection device and the current temperature is equal to or greater than a predetermined value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a method for determining a timing for replacing a filter for a projector according to a prior art.

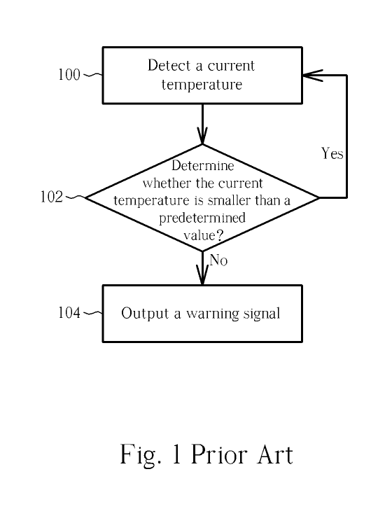

FIG. 2 is a diagram of a projection device according to the present invention.

FIG. 3 is a flowchart of a method for determining a timing for replacing a filter for the projection device in FIG. 2.

### DETAILED DESCRIPTION

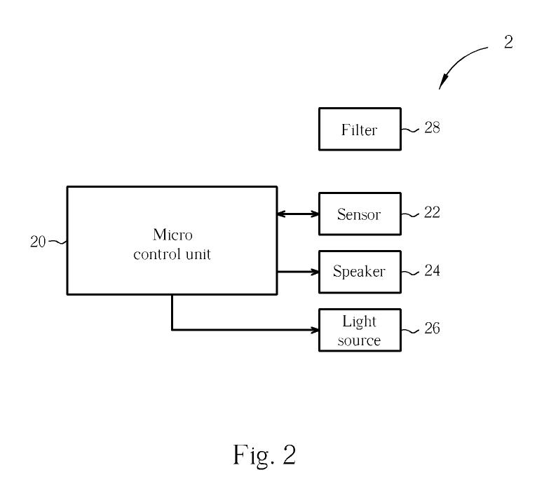

Please refer to FIG. 2. FIG. 2 is a diagram of a projection device 2 according to the present invention. The projection device 2 comprises a micro control unit 20 for controlling the projection device 2, a sensor 22 coupled to the micro control unit 20 for detecting a current temperature inside the projection device 2, a speaker 24, a light source 26, and a filter 28 installed at an air inlet in the projection device 2. When a temperature variation between an initial working temperature of the projection device 2 and the current temperature inside the projection device 2 is equal to or greater than a predetermined value, the projection device 2 will output a warning signal to remind a user to replace a filter. The warning signal can be an audio warning generated by the speaker 24 or a visual warning generated by the light source 26.

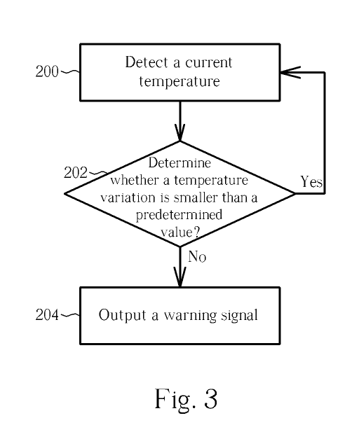

Please refer to FIG. 3. FIG. 3 is a flowchart of a method for determining a timing for replacing the filter for the projection device 2 according to the present invention. The method comprises the following steps:

Step 200: the sensor 22 detects a current temperature inside the projection device 2.

Step 202: determine whether a temperature variation between the current temperature detected in Step 200 and the initial working temperature of the projection device 2 is smaller than a predetermined value. If so, go to Step 200. If not, go to Step 204.

Step 204: the projection device 2 outputs a warning signal generated by the speaker 24 or the light source 26 to remind a user to replace the filter.

More detailed description for the initial working temperature of the projection device 2 mentioned in Step 202 will be provided. The projection device 2 needs to be examined after it is manufactured. After being examined, the inner temperature of the projection device 2 is obtained during the first operation. Then, the obtained temperature will be set as an initial working temperature of the projection device 2 and be recorded in the projection device 2.

Furthermore, the predetermined value mentioned in Step 202 is set according to a temperature variation inside the projection device 2 while the filter is choked. The present invention determines a timing for replacing a filter according to the said temperature variation so that misjudging a timing for replacing a filter due to the ignorance of the difference among the initial working temperature of each individual projection device can be avoided.

For example, suppose that an initial working temperature of a projection device A is 50° C., an initial working temperature of a projection device B is 70° C., and a predetermined value is 20° C. That is to say, a warning signal for replacing the filter is not output until temperature inside the projection device B reaches 90° C. or temperature inside the projection device A reaches 70° C. Therefore, no matter what the initial working temperature is, the projection device will output a warning signal to remind the user to replace the filter as soon as a temperature variation between its current temperature and its initial working temperature reaches the predetermined value (20° C.).

The projection device 2 according to the present invention can be a rear-projection television, a cathode ray tube projector, a liquid crystal display projector, a digital light processing projector, or a liquid crystal on silicon projector. The light source 26 in the projection device 2 can be a light-emitted diode or other devices for supplying a light.

Because the method according to the present invention involves determining whether the user has to replace the filter for the projection device based on a temperature variation inside the projection device, misjudging the timing for replacing the filter can be avoided.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for determining a timing for replacing a filter for a projection device, the method comprising:
detecting a current temperature inside the projection device; and
outputting a warning signal for replacing the filter when a temperature variation between an initial working temperature of the projection device and the current temperature is equal to or greater than a predetermined value.

2. The method of claim 1 further comprising testing the projection device for setting the initial working temperature.

3. The method of claim 1, wherein detecting the current temperature inside the projection device comprises detecting a temperature inside the projection device while the projection device is operating.

4. The method of claim 1 further comprising recording the initial working temperature in the projection device.

5. A projection device capable of determining a timing for replacing filters, the projection device comprising:
a filter;
a warning device for outputting a warning signal as a reminder of replacing the filter;
a sensor for detecting a current temperature inside the projection device; and
a micro control unit coupled to the warning device and the sensor for controlling the warning device to output the warning signal when a temperature variation between an initial working temperature of the projection device and the current temperature is equal to or greater than a predetermined value.

6. The projection device of claim 5, wherein the warning device is a speaker.

7. The projection device of claim 5, wherein the warning device is a light source.

8. The projection device of claim 7, wherein the warning device is a light-emitting diode (LED).

9. The projection device of claim 5 being a projector.

10. The projection device of claim 5 being a rear-projection television.

11. The projection device of claim 5 being a cathode ray tube projector.

12. The projection device of claim 5 being a liquid crystal display projector.

13. The projection device of claim 5 being a digital light processing projector.

14. The projection device of claim 5 being a liquid crystal on silicon projector.
